(19) United States
(12) Patent Application Publication
(10) Pub. No.: US 2005/0103288 A1
(43) Pub. Date: May 19, 2005

(54) Dual piston engine rigid rocker marriage

(76) Inventor: Leroy Edwards JR., Riverside, CA (US)

Correspondence Address: LEROY EDWARDS JR., P. O. BOX 4324, RIVERSIDE, CA, 92514, US

(21) Appl. No.: 10/714,322

(22) Filed: Nov. 14, 2003

(51) Int. Cl. F02B 75/28

(52) U.S. Cl. 123/51 R

(57) ABSTRACT

Let's compare rigid rockers #7 and #8, to the crank assembly of U.S. Pat. No. 6,250,263 and U.S. Pat. No. 5,133,306, FIG. 8. U.S. Pat. No. 5,133,306, FIG. 8 clearly exhibits three crank shafts, two auxiliary crank shafts located on either side of the main output crankshaft. Neither crank shaft is interchangeable, and are much heavier than the rigid rockers. The engine shown is a two cylinder engine which houses four pistons, this means that four rigid rockers would be required to replace the two auxiliary cranks which would significantly impact the cost of this engine, the weight, and should increase the life of the engine. The overall friction would decrease tremendously, since the rigid rockers FIG. 1, 7 & 8 and of my invention do not rotate. They actuate to and fro approximately 45° each direction causing a 360° rotation of the main crank shaft.

### FIELD OF INVENTION

### DUAL PISTON INTERNAL COMBUSTION ENGINE

### CROSS-REFERENCE

1. U.S. Pat. No. 6,250,263 will reference a few descriptions of this invention which are inferior to the description of my text:

2. Page 2 of 13, paragraph 1, sub-paragraph which reads “at least two cylinders, each said cylinder having separate crank ends, separate face ends and separate central axis.”

3. Page 3 of 13, paragraph 11, sub-paragraph which reads “at least two cylinders, each said cylinder having separate crank ends, separate face ends and separate central axes.”

4. Page 4 of 13, paragraph 14, sub-paragraph which reads “at least two cylinders, each cylinder having a crank end and a face end.”

5. Page 4 of 13, paragraph 19, sub-paragraph which reads “at least two cylinders, each said cylinder having separate crank ends, separate face ends and separate central axes.

### BACK GROUND OF THE INVENTION

The dual rigid rocker marriage should revolutionize the dual piston engine. This concept is the most economical way to inner connect the dual piston to the output train. This rigid rocker marriage will finally enable the dual piston concept to be constructed economically and be more efficient than the separate crank end concept.

### BRIEF SUMMARY OF THE INVENTION

The dual piston concept, utilizing the rigid rockers can be constructed much lighter and smaller, do the same amount of work, using less fuel, and have longer life. Rigid rockers will significantly reduce the cost, increase performance, and reduce the weight of a dual piston engine. This engine concept may operate using any fuel, Liquefied Natural Gas (LNG) diesel, gasoline, or kerosene.

### DETAILED DESCRIPTION OF THE INVENTION

In FIG. 1

1. Dual pistons (1) and (2) move outward on its combustion cycle, forcing rigid rockers 7 and 8 away from each other at points (3) and (4). Points (9) and (10) are forced towards each other, causing a clock wise rotating action of points (11) and (12) this energy is transferred to output shaft (13). Points (5) and (6) are center support axis for the rigid rockers 7 and 8. While the dual pistons move away from each other, they travel approximately 1/2 the distance of a single piston conventional engine, allowing a dual piston engine to cycle at higher (RPM) rotations per minute.

2. In a single piston concept, the single piston cycles in it's cylinder against a fixed head, causing some energy to be lost compared to this dual concept.

3. In this dual concept, the two opposing pistons travel too and fro in a single cylinder allowing for higher compression in the cylinder, which will increase the engine's efficiency.

4. By the two pistons moving to and fro in a single cylinder will allow for greater heat dissipation. A great amount of heat is generated against the stationary head of a single piston cylinder requiring greater cooling action of the head. The additional heat generated against the stationary head of a conventional engine may equal additional energy loss and ware.

5. Due to the imposing thrust upon the crank shaft 90° apart in a dual piston configuration will cause equal opposing forces upon the crank shaft. These opposing forces will cause main bearing ware to be closer to zero.

6. Proportionally, more work will be accomplished in a dual piston engine, using less fuel to achieve the same work.

7. Due to pistons (1) and (2) traveling about ½ the distance of a conventional engine, each piston will ware longer.

8. By the rockers 7 and 8 actuating to and fro approximately 45° in each direction from their axis at (5) and (6) the piston rods wag less on their axis (1), (2), (3)& (4) in a complete 4 cycle revolution compared to a 360° cycle of a conventional engine. The “dual face to face rigid rocker marriage concept” will enable the construction of piston rods and pistons to be much lighter in weight, allowing for higher RPM'S.

9. The connecting links (9) and (10) may be constructed more rigidly to the crank since piston rods (3) and (4) won't be directly associated to the output crank.

10. The rigid rockers 7 and 8 may be constructed much cheaper than a crank shaft, and will certainly last longer, since there won't be a 360° cycle. These rockers will cycle about 45° to and fro of its axis (5) and (6) 4 strokes to complete 4 cycles of the engine operation (intake-compression-combustion, and exhaust).

In FIG. 3:

21 is replaceable bushings
22 is replaceable hinge pin which hinges rigid rocker on its center axis.
23 is replaceable hinge pin which connects connecting rod from rigid rocker to main output crankshaft.
24 is replaceable hinge pin which connects piston rod from rigid rocker to piston.

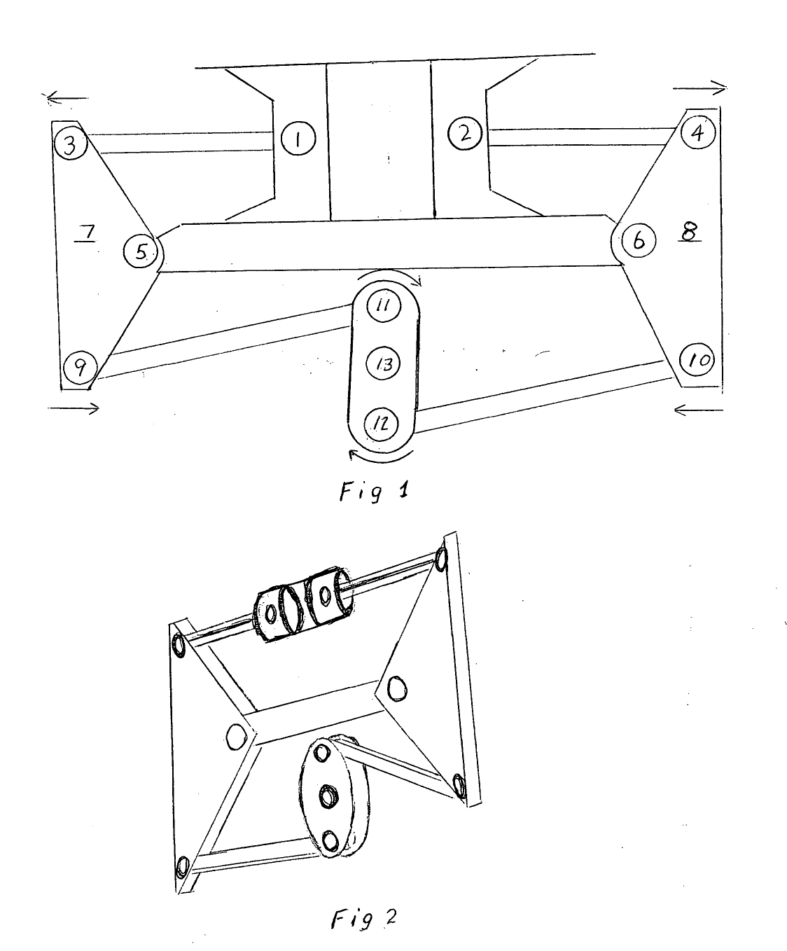

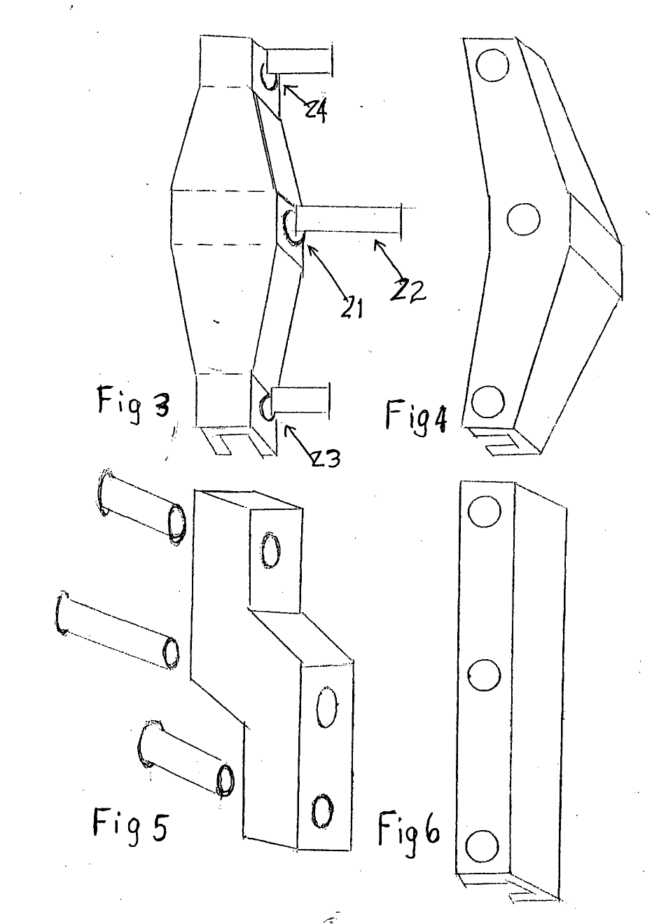

FIG. 4 is rockers designed to shorten the piston rods and the crankshaft rods of my invention.

FIG. 5 of my invention is offset rockers which will specifically accommodate the offset cylinders of invention #6250263.

FIG. 6 is straight axis which may not require altering the piston rods and crankshaft rods of my invention

1. The incorporation of 2 rigid rockers in a face to face, dual piston engine. Reference FIG. 1, rockers 7 and 8. Each Rigid Rocker will be hinged at points # 5 and # 6. Points # 3 and # 4 of rigid rockers are hinged to the piston rods which connect to the pistons of the dual piston engine. Points # 9 and # 10 of the rigid rockers are hinged to 2 sets of push/pull rods which will connect to the main crank at points #11 and #12. The pistons move from top dead center to bottom. Thus, reciprocating action is converted to rotating action at the output crankshaft.

2. FIG. 3, FIG. 4, FIG. 5, FIG. 6, are typical designs of my invention as in claim 1.

3. Rigid rockers of any configuration or design which would facilitate the connection of the pistons to the output crank shaft in a dual face to pace piston engine is a description of my invention.
